(19) United States
(12) Patent Application Publication
(10) Pub. No.: US 2023/0147805 A1
(43) Pub. Date: May 11, 2023

(54) Method for Generating Training Data for Training a Machine Learning Algorithm

(71) Applicant: Robert Bosch GmbH, Stuttgart (DE)

(72) Inventors: Konrad Groh, Stuttgart (DE); Matthias Woehrle, Bietigheim-Bissingen (DE)

(21) Appl. No.: 18/054,266

(22) Filed: Nov. 10, 2022

(30) Foreign Application Priority Data
Nov. 11, 2021 (DE) 10 2021 212 728.2

(51) Int. Cl. G06N 20/00

(52) U.S. Cl. CPC G06N 20/00

(57) ABSTRACT

A method is for generating training data for training a machine learning algorithm. The training data respectively include a data point and a data value associated with the data point. The method includes providing first training data for training the machine learning algorithm, providing an additional data point, and approximating nearest neighbors of the additional data point based on the data points of the first training data. The method further includes determining a data value associated with the additional data point from data values associated with the nearest neighbors of the additional data point. A data pair, including the additional data point and the data value associated with the additional data point, forms additional training data.

This application claims priority under 35 U.S.C. § 119 to patent application no. DE 10 2021 212 728.2, filed on Nov. 11, 2021 in Germany, the disclosure of which is incorporated herein by reference in its entirety.

The disclosure relates to a method for generating training data for training a machine learning algorithm, and in particular to a method designed to generate additional training data in a simple manner and with low resource consumption.

### BACKGROUND

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

A system to be modeled can be acquired by means of measurements, for example, wherein an empirical model can be created based on measured values, for example, and a machine learning algorithm can be trained accordingly. However, in this case, situations in which it is impossible to completely measure a process to be modeled or a system to be modeled may, for example, occur. However, this may result in only partial data from a subspace being available for the empirical modeling or the corresponding training of the machine learning algorithm, wherein process states that are not captured by these training data can, however, also occur in operation.

As a solution to this problem, augmentation methods, i.e., methods for generating additional training data, have been proposed. However, with known augmentation methods, it proves disadvantageous that they are very complex and require many computer resources, in particular storage and computing capacities, so that they are difficult to realize with ordinary data processing systems.

A method for learning a data supplementation strategy for training a machine learning algorithm is known from the publication US 2019/0354895 A1, wherein training data for training a machine learning algorithm are received and a plurality of data supplementation strategies are determined by generating a current data supplementation strategy based on quality parameters of previous data supplementation strategies, the machine learning algorithm is trained based on the current data supplementation strategy and quality parameters with respect to the current data supplementation strategy are determined after the machine learning algorithm has been trained based on the current data supplementation strategy, wherein a data supplementation strategy is subsequently selected based on the quality parameters of the individual data supplementation strategies.

The disclosure is thus based on the object of specifying an improved method for generating training data for training a machine learning algorithm.

### SUMMARY

The object is achieved by a method for generating training data for training a machine learning algorithm as disclosed herein. The object is also achieved by a control device for generating training for training and a machine learning algorithm as disclosed herein. Advantageous embodiments and developments emerge from the dependent claims and from the description with reference to the figures.

According to one embodiment of the disclosure, this object is solved by a method for generating training data for training a machine learning algorithm, wherein the training data respectively comprise a data point and a data value associated with the data point, and wherein first training data are provided for training the machine learning algorithm, an additional data point is provided, nearest neighbors of the additional data point are approximated based on the data points of the first training data, and a data value associated with the additional data point is determined from data values associated with the nearest neighbors of the additional data point, wherein the pair of the additional data point and the data value associated with the additional data point forms additional training data.

Data points are understood herein as information carriers or units of information representing input variables of the machine learning algorithm, i.e., data that can be processed by the machine learning algorithm.

Data values or function values are furthermore understood as information carriers and units of information respectively representing an output variable of the machine learning algorithm, i.e., an output variable generated by processing a corresponding input variable by means of the machine learning algorithm.

One possibility of classifying data or associating data values with data points is the nearest neighbor classification, wherein a data value for a data point is determined based on the nearest neighbors of the data point, i.e., based on further data points that have a comparatively short distance to the data point and are adjacent to the data point. However, such an approach assumes that all data points from one amount of data must be considered in order to determine the nearest neighbors of the data point, which, however, has a square complexity and is inefficient, especially with increasing amounts of data or amounts of data from a high-dimensional space.

The advantage of approximating or estimating the nearest neighbors in doing so is that when determining the nearest neighbors, all data points from the amount of data no longer need to be considered, which, especially with increasing amounts of data or amounts of data from a high-dimensional space, proves advantageous with regard to computer resources, e.g., storage and/or computing capacity.

Overall, a method is thus specified with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the method can in particular even be performed on control devices with limited computing resources.

Overall, an improved method for generating training for training a machine learning algorithm is thus specified.

In one embodiment, the method furthermore comprises applying robust statistics to the data values associated with the nearest neighbors of the additional data point, in order to detect outliers in the data values associated with the nearest neighbors of the additional data point, wherein the data value associated with the additional data point is determined from the data values that are associated with the nearest neighbors of the additional data point and that do not represent an outlier at the same time.

Robust statistics are understood to mean an estimation or test method that is not sensitive to outliers, i.e., values outside of a value range expected due to a distribution, and that thus reliably detects outliers in data, in particular the data values associated with the nearest neighbors.

Since approximations are comparatively susceptible to error, it may occur that data values associated with individual ones of the approximated nearest neighbors are not consistent with the data values of the other approximated nearest neighbors. Such outliers not being considered in the determination of the data value associated with the additional data point has the advantage that such errors introduced during approximation can be compensated again when determining the data value associated with the additional data point.

Furthermore, the step of determining the data value associated with the additional data point from data values associated with the nearest neighbors of the additional data point may comprise determining the median of the data values associated with the nearest neighbors of the additional data point. In particular, the data value associated with the additional data point may correspond to the median of the data values associated with the approximated nearest neighbors of the additional data point.

The median or median value is understood to mean the value that is exactly in the middle of a data distribution, here in the middle of the data values associated with the nearest neighbors.

The data value associated with the additional data point can thus be determined in a simple manner and with low consumption of computing resources.

The data value associated with the additional data point corresponding to the median of the data values associated with the approximated nearest neighbors of the additional data point is however only one possible embodiment. Rather, the data value associated with the additional data point may also, for example, correspond to the average of the data values associated with the approximated nearest neighbors of the additional data point.

The first training data may furthermore be sensor data or data captured by a sensor.

A sensor, which is also referred to as a detector, (measurement or measuring) sensor or (measuring) transmitter, is a technical part that can qualitatively detect particular physical or chemical properties and/or the material characteristics of its surroundings or detect them quantitatively as a measured variable.

Thus, circumstances outside the actual data processing system on which the additional training data are generated can be captured in a simple manner and can be taken into account when generating the additional training data.

With a further embodiment of the disclosure, a method for training a machine learning algorithm is also specified, wherein first training data and additional training data are provided by a method described above for generating training data for training a machine learning algorithm, and wherein the machine learning algorithm is trained based on the first training data and the additional training data.

A method for training a machine learning algorithm which is based on training data generated by an improved method for generating training data for training a machine learning algorithm is thus specified. In particular, the method is based on a method for generating training data for training a machine learning algorithm, with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the method can in particular even be performed on control devices with limited computing resources.

With a further embodiment of the disclosure, a method for controlling at least one function of a controllable system is furthermore also specified, wherein a machine learning algorithm is provided for controlling the at least one function of the controllable system, wherein the machine learning algorithm has been trained by a method described above for training a machine learning algorithm, and wherein the at least one function of the controllable system is controlled based on the machine learning algorithm.

The controllable system may, for example, be a robotic system, wherein the robotic system may, for example, be an injection system of an internal combustion engine. Furthermore, the robotic system may, for example, however also be any other system that can be controlled based on a machine learning algorithm, e.g., driver assistance systems of a motor vehicle, a kitchen appliance or a washing machine.

A method is thus specified for controlling at least one function of a controllable system that is based on a machine learning algorithm that has been trained based on training data generated by an improved method for generating training data for training a machine learning algorithm. In particular, the training data in this case were generated by a method for generating training data for training a machine learning algorithm, with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the method can in particular even be performed on control devices with limited computing resources.

With a further embodiment of the disclosure, a control device for generating training data for training a machine learning algorithm is moreover also specified, wherein the training data respectively comprise a data point and a data value associated with the data point, and wherein the control device comprises a first provision unit designed to provide first training data, a second provision unit designed to provide an additional data point, an approximation unit designed to approximate nearest neighbors of the additional data point based on the data points of the first training data, and a determination unit designed to determine a data value associated with the additional data point from data values associated with the nearest neighbors of the additional data point, wherein the pair of the additional data point and the data value associated with the additional data point forms additional training data.

Overall, an improved control device for generating training data for training a machine learning algorithm is thus specified. In particular, a control device is specified with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the control device can in particular even be a control device with limited computing resources.

In one embodiment, the control device furthermore comprises an application unit designed to apply robust statistics to the data values associated with the nearest neighbors of the additional data point, in order to detect outliers in the data values associated with the nearest neighbors of the additional data point, wherein the determination unit is designed to determine the data value associated with the additional data point from the data values that are associated with the nearest neighbors of the additional data point and that do not represent an outlier. Since approximations are comparatively susceptible to error, it may occur that data values associated with individual ones of the approximated nearest neighbors are not consistent with the data values of the other approximated nearest neighbors. Such outliers not being considered in the determination of the data value associated with the additional data point has the advantage that such errors introduced during approximation can be compensated again when determining the data value associated with the additional data point.

Moreover, the determination unit may be designed to determine the data value associated with the additional data point by determining the median of the data values associated with the nearest neighbors of the additional data point. The data value associated with the additional data point can thus be determined in a simple manner and with low consumption of computing resources.

Again, the first training data may furthermore be sensor data or data captured by a sensor. Thus, circumstances outside the actual data processing system on which the additional training data are generated can be captured in a simple manner and can be taken into account when generating the additional training data.

With a further embodiment of the disclosure, a control device for training a machine learning algorithm is furthermore also specified, wherein the control device comprises a provision unit designed to provide first training data and additional training data, wherein the additional training data have been generated by a control device described above for generating training data for training a machine learning algorithm, and a training unit designed to train the machine learning algorithm based on the first training data and the additional training data.

A control device for training a machine learning algorithm, which is designed to train a machine learning algorithm based on training data generated by an improved method for generating training data for training a machine learning algorithm, is thus specified. In particular, the additional training data in this case are generated by a method for generating training data for training a machine learning algorithm, with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the corresponding method for generating training data for training the machine learning algorithm can in particular even be performed on control devices with limited computing resources.

With a further embodiment of the disclosure, a control device for controlling at least one function of a controllable system is furthermore also specified, wherein the control device comprises a provision unit designed to provide a machine learning algorithm for controlling the at least one function of the controllable system, wherein the machine learning algorithm has been trained by a control device described above for training a machine learning algorithm, and a control unit designed to control the at least one function of the controllable system based on the machine learning algorithm.

A control device is thus specified for controlling at least one function of a controllable system that is based on a machine learning algorithm that has been trained based on training data generated by an improved method for generating training data for training a machine learning algorithm. In particular, the training data in this case were generated by a method for generating training data for training a machine learning algorithm, with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the method for generating training data for training the machine learning algorithm can in particular even be performed on control devices with limited computing resources.

In summary, it must be noted that the disclosure specifies a method for generating training data for training a machine learning algorithm, and in particular a method designed to generate additional training data in a simple manner and with low resource consumption.

The described embodiments and developments can be combined with one another as desired.

Other possible embodiments, developments and implementations of the disclosure also include not explicitly mentioned combinations of features of the disclosure described above or below with respect to exemplary embodiments.

### BRIEF DESCRIPTION OF THE DRAWINGS

The accompanying drawings are intended to provide a further understanding of the embodiments of the disclosure. They illustrate embodiments and, in connection with the description, serve to explain principles and concepts of the disclosure.

Other embodiments and many of the mentioned advantages become apparent from the drawings. The illustrated elements of the drawings are not necessarily shown to scale with respect to one another. In the figures:

FIG. 1 shows a flow chart of a method for controlling at least one function of a controllable system according to embodiments of the disclosure; and

FIG. 2 shows a schematic block diagram of a system for controlling at least one function of a controllable system according to embodiments of the disclosure.

### DETAILED DESCRIPTION

In the figures of the drawings, identical reference numbers denote identical or functionally identical elements, parts or components, unless stated otherwise.

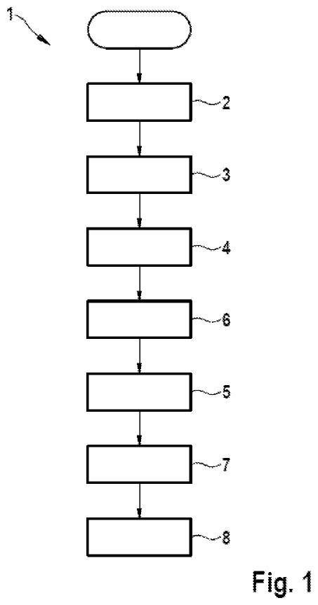

FIG. 1 shows a flow chart of a method 1 for controlling at least one function of a controllable system according to embodiments of the disclosure.

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

A system to be modeled can be acquired by means of measurements, for example, wherein an empirical model can be created based on measured values, for example, and a machine learning algorithm can be trained accordingly. However, in this case, situations in which it is impossible to completely measure a process to be modeled or a system to be modeled may, for example, occur. However, this may result in only partial data from a subspace being available for the empirical modeling or the corresponding training of the machine learning algorithm, wherein process states that are not captured by these training data can, however, also occur in operation.

As a solution to this problem, augmentation methods, i.e., methods for generating additional training data, have been proposed. For example, it is known to augment data by Gaussian noise or image data by image processing methods. However, with known augmentation methods, it proves disadvantageous that they are very complex and require many computer resources, in particular storage and computing capacities, so that they are difficult to realize with ordinary data processing systems.

FIG. 1 shows a method 1, wherein the training data respectively comprise a data point and a data value associated with the data point, and wherein in a step 2, first training data are provided for training the machine learning algorithm, in a step 3, an additional data point is provided, in a step 4, nearest neighbors of the additional data point are approximated based on the data points of the first training data, and in a step 5, a data value associated with the additional data point is determined from data values associated with the nearest neighbors of the additional data point, wherein the pair of the additional data point and the data value associated with the additional data point forms additional training data.

Overall, FIG. 1 thus shows a method 1 with which the generation of additional training data can be significantly simplified even with large amounts of data or higher-resolution data and additional training data can be generated in a simple manner and with comparatively low resource consumption, e.g., low storage and/or computing capacities. For example, if the first training data are time points from large and/or continuously growing time series, the effort associated with generating additional training data can be significantly simplified so that the method can in particular even be performed on control devices with limited computing resources.

The first training data may, for example, be measured values that show relationships between input and output values of a function controlled by the machine learning algorithm and based on which the machine learning algorithm is to be trained.

The additional data point may furthermore, for example, be a data point newly generated based on a measurement or by synthesis, wherein a value or a class for the newly generated data point is to be determined.

The data values associated with the nearest neighbors can in this case be read from the corresponding first training data.

Furthermore, the training data generated by the method 1 may also be used to test or validate already trained machine learning algorithms.

According to the embodiments of FIG. 1, a nearest neighbor graph is approximated based on the data points of the first training data, i.e., all data points contained or included in the first training data, and then, based on this nearest neighbor graph, the nearest neighbors of the additional data point are determined.

Furthermore, the nearest neighbors of the additional data point may however also be approximated based on a locality sensitive hashing, for example.

As FIG. 1 shows, the method furthermore comprises a step 6 of applying robust statistics to the data values associated with the nearest neighbors of the additional data point, in order to detect outliers in the data values associated with the nearest neighbors of the additional data point, wherein the data value associated with the additional data point is determined from the data values that are associated with the nearest neighbors of the additional data point and that do not represent an outlier at the same time.

Applying the robust statistics may, for example, be the use of quantiles or predetermined threshold values.

According to the embodiments of FIG. 1, step 5 of determining the data value associated with the additional data point from data values associated with the nearest neighbors of the additional data point comprises determining the median from the data values associated with the nearest neighbors of the additional data point.

According to the embodiments of FIG. 1, the first training data furthermore comprise sensor data. The sensor data may, for example, be acquired from an optical sensor, such as a video sensor, a RADAR, a LiDAR, or a motion sensor, for example.

Steps 2, 3, 4, 5, and 6 may be performed repeatedly, particularly until sufficient training data for training the machine learning algorithm are available.

As FIG. 1 furthermore shows, method 1 furthermore comprises a step 7 of training the machine learning algorithm based on the first training data and the generated additional training data.

Moreover, FIG. 1 shows a step 8 of controlling at least one function of a controllable system based on the trained machine learning algorithm.

The controllable system may, for example, be an injection system of an internal combustion engine, wherein the machine learning algorithm is designed in such a way that the respective opening and/or closing time point of the injection valve can be determined based on a data-based time point determination model.

Furthermore, the controllable system may, for example, be an analyzer, e.g., an analyzer for analyzing samples for the presence of viruses, wherein the method can be applied to corresponding image data.

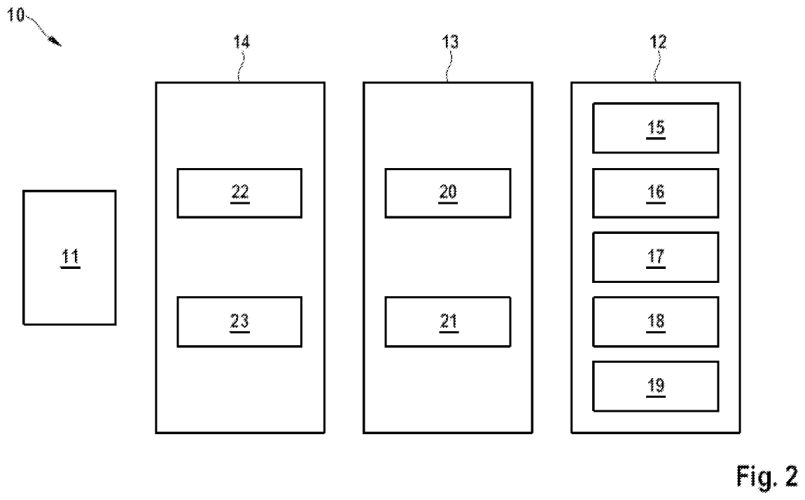

FIG. 2 shows a schematic block diagram of a system 10 for controlling at least one function of a controllable system 11 according to embodiments of the disclosure.

The controllable system 11 may, for example, be a robotic system, wherein the robotic system may, for example, be an injection system of an internal combustion engine. Furthermore, the robotic system may, for example, however also be any other system that can be controlled based on a machine learning algorithm, e.g., driver assistance systems of a motor vehicle, a kitchen appliance or a washing machine.

As FIG. 2 shows, the system 10 comprises a control device 12 for generating training data for training the machine learning algorithm, a control device 13 for training the machine learning algorithm, and a control device 14 for controlling at least one function of a controllable system.

According to the embodiments of FIG. 2, the control device 12 for generating training data for training the machine learning algorithm comprises a first provision unit 15 designed to provide first training data, a second provision unit 16 designed to provide an additional data point, an approximation unit 17 designed to approximate nearest neighbors of the additional data point based on the data points of the first training data, and a determination unit 18 designed to determine a data value associated with the additional data point from data values associated with the nearest neighbors of the additional data point, wherein the pair of the additional data point and the data value associated with the additional data point forms additional training data.

The first provision unit may, for example, be designed as a receiver, wherein the receiver is designed to receive the first training data, e.g., sensor data. The second provision unit may, for example, likewise be designed as a receiver, wherein the receiver is designed to receive the additional data point. The approximation unit and the determination unit may furthermore respectively be implemented, for example, based on code that is stored in a memory and can be executed by a processor.

As FIG. 2 furthermore shows, the control device 12 furthermore comprises an application unit 19 designed to apply robust statistics to the data values associated with the nearest neighbors of the additional data point, in order to detect outliers in the data values associated with the nearest neighbors of the additional data point, wherein the determination unit 18 is designed to determine the data value associated with the additional data point from the data values that are associated with the nearest neighbors of the additional data point and that do not represent an outlier at the same time.

Again, the application unit may furthermore be implemented, for example, based on code that is stored in a memory and can be executed by a processor.

In particular, the determination unit 18 according to the embodiments of FIG. 2 is designed to determine the data value associated with the additional data point by determining the median of the data values associated with the nearest neighbors of the additional data point.

According to the embodiments of FIG. 2, the first training data are furthermore again sensor data

As FIG. 2 furthermore shows, the control device 13 for training the machine learning algorithm furthermore comprises a further provision unit 20 designed to provide first training data and additional training data, wherein the additional training data have been generated by the control device 12 for generating training data for training a machine learning algorithm, and a training unit 21 designed to train the machine learning algorithm based on the first training data and the additional training data.

The further provision unit may, for example, again be designed as a receiver, wherein the receiver is designed to receive the generated additional training data and optionally also the first training data from the control device for generating training data for training the machine learning algorithm. Again, the training unit may furthermore be implemented, for example, based on code that is stored in a memory and can be executed by a processor.

As FIG. 2 moreover shows, the control device 14 for controlling at least one function of a controllable system yet comprises a further provision unit 22 designed to provide the machine learning algorithm for controlling the at least one function of the controllable system, wherein the machine learning algorithm has been trained by the control device 13 for training the machine learning algorithm, and a control unit 23 designed to control the at least one function of the controllable system based on the machine learning algorithm.

The provision unit may, for example, again be designed as a receiver, wherein the receiver is designed to receive the trained machine learning algorithm from the control device for training the machine learning algorithm. The control unit may furthermore comprise corresponding actuators and/or may again at least in part be implemented, for example, based on code that is stored in a memory and can be executed by a processor.

What is claimed is:

1. A method for generating training data for training a machine learning algorithm, the training data respectively comprise a data point and a data value associated with the data point, the method comprising:
providing first training data for training the machine learning algorithm;
providing an additional data point;
approximating nearest neighbors of the additional data point based on the data points of the first training data;
determining a data value associated with the additional data point from data values associated with the nearest neighbors of the additional data point; and
forming additional training data including a data pair having the additional data point and the data value associated with the additional data point.

2. The method according to claim 1, further comprising:
applying robust statistics to the data values associated with the nearest neighbors of the additional data point, in order to detect outliers in the data values associated with the nearest neighbors of the additional data point, and
the data value associated with the additional data point is determined from the data values that are associated with the nearest neighbors of the additional data point and that do not represent an outlier.

3. The method according to claim 1, wherein determining the data value associated with the additional data point from data values associated with the nearest neighbors of the additional data point comprises determining a median of the data values associated with the nearest neighbors of the additional data point.

4. The method according to claim 1, wherein the first training data comprise sensor data.

5. A method for training a machine learning algorithm, comprising:
providing first training data and forming additional training data according to the method of claim 1; and
training the machine learning algorithm based on the first training data and the additional training data.

6. A method for controlling at least one function of a controllable system, comprising:
providing a machine learning algorithm for controlling the at least one function of the controllable system, the machine learning algorithm having been trained according to the method of claim 5; and
controlling the at least one function of the controllable system based on the trained machine learning algorithm.

7. A control device for generating training data for training a machine learning algorithm, the training data respectively comprise a data point and a data value associated with the data point, the control device comprising:
a first provision unit configured to provide first training data;
a second provision unit configured to provide an additional data point;
an approximation unit configured to approximate nearest neighbors of the additional data point based on the data points of the first training data; and
a determination unit configured to determine a data value associated with the additional data point from data values associated with the nearest neighbors of the additional data point,
wherein a data pair including the additional data point and the data value associated with the additional data point forms additional training data.

8. The control device according to claim 7, further comprising:
an application unit configured to apply robust statistics to the data values associated with the nearest neighbors of the additional data point, in order to detect outliers in the data values associated with the nearest neighbors of the additional data point,
wherein the determination unit is configured to determine the data value associated with the additional data point from the data values that are associated with the nearest neighbors of the additional data point and that do not represent an outlier.

9. The control device of according to claim 7, wherein the determination unit is configured to determine the data value associated with the additional data point by determining the median of the data values associated with the nearest neighbors of the additional data point.

10. The control device according to claim 7, wherein the first training data comprise sensor data.

11. A control device for training a machine learning algorithm, comprising:
a provision unit configured to provide first training data and to form additional training data, the additional training data have been formed by the control device of claim 7; and
a training unit configured to train the machine learning algorithm based on the first training data and the additional training data.

12. A control device for controlling at least one function of a controllable system, comprising:
a provision unit configured to provide a machine learning algorithm for controlling the at least one function of the controllable system, the machine learning algorithm trained by the control device of claim 11; and
a control unit configured to control the at least one function of the controllable system based on the machine learning algorithm.
